(19) United States
(12) Patent Application Publication
(10) Pub. No.: US 2026/0105624 A1
(43) Pub. Date: Apr. 16, 2026

(54) Polarization-Based Underwater Geolocalization with Deep Learning

(71) Applicant: The Board of Trustees of the University of Illinois, Urban, IL (US)

(72) Inventors: Viktor GRUEV, Champaign, IL (US); David A. FORSYTH, Irbama, IL (US)

(21) Appl. No.: 18/912,955

(22) Filed: Oct. 11, 2024

Related U.S. Application Data
(60) Provisional application No. 63/590,151, filed on Oct. 13, 2023.

(51) Int. Cl. G06T 7/70

(52) U.S. Cl. CPC G06T 7/70; G06T 2207/10016; G06T 2207/20084

(57) ABSTRACT

The present disclosure describes various methods, systems, and storage medium for determining underwater geolocation from polarization images with neural networks. The method includes obtaining a plurality of polarization images; inputting the plurality of polarization images to a first neural network to obtain a set of location predictions; refining the set of location predictions with a second neural network to obtain a set of refined location predictions; estimating a geolocation according to the set of refined location predictions; and outputting the estimated geolocation.

### RELATED APPLICATION

This application is based on and claims the benefit of priority to U.S. Provisional Application No. 63/590,151 filed on Oct. 13, 2023, which is herein incorporated by reference in its entirety.

### GOVERNMENT LICENSE RIGHTS

This invention was made with government support under N00014-19-1-2400 awarded by the Office of Naval Research. The government has certain rights in the invention.

### FIELD OF THE INVENTION

This disclosure relates to a method and system for using neural networks to determining geolocations, particularly determining underwater geolocation from light polarization images.

### BACKGROUND OF THE INVENTION

Water is an essential component of the Earth's climate, but monitoring its properties using autonomous underwater sampling robots remains a significant challenge due to lack of underwater geolocalization capabilities. Some implementations for underwater geolocalization may rely on tethered systems with limited coverage or daytime imagery data in clear waters, which may have various problems or issues with respect to some underwater environment. For non-limiting examples, there are some problems and/or issues for geolocalization in turbid waters or at night due to absence of identifiable landmarks.

The present disclosure describes various embodiments for determining geolocations using neural networks, addressing some of the problems/issues discussed above. The various embodiments increase the accuracy of underwater geolocation, expand applicability scope of underwater geolocation, and/or advance the geolocation technology.

### SUMMARY OF THE INVENTION

In view of this, embodiments of the present disclosure are expected to provide a method, apparatus, and a storage medium for determining underwater geolocation from polarization images with neural networks.

According to one aspect, an embodiment of the present disclosure provides a method for determining underwater geolocation from polarization images with neural networks. The method includes obtaining, by a device, a plurality of polarization images. The device includes a memory and a processor in communication with the memory. The method further includes inputting, by the device, the plurality of polarization images to a first neural network to obtain a set of location predictions; optionally refining, by the device, the set of location predictions with a second neural network to obtain a set of refined location predictions; estimating, by the device, a geolocation according to the set of refined location predictions; and outputting, by the device, the estimated geolocation.

An apparatus for determining underwater geolocation from polarization images with neural networks, wherein the apparatus is configured to perform a portion or all of the above methods.

An system for determining underwater geolocation from polarization images with neural networks, wherein the system is configured to perform a portion or all of the above methods.

A non-transitory computer program product comprising a computer-readable program medium code stored thereupon, the computer-readable program medium code, when executed by a processor, causing the processor to perform a portion or all of the above methods.

A non-transitory computer-readable program medium storing codes, the codes, when executed by a processor, causing the processor to perform a portion or all of the above methods.

The above and other aspects and their implementations are described in greater detail in the drawings, the descriptions, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The system, device, product, and/or method described in the present disclosure may be better understood with reference to the following drawings and description of non-limiting and non-exhaustive embodiments. The components in the drawings are not necessarily to scale, and reference is made to the following drawings, in which:

FIG. 1 is a schematic diagram of an exemplary embodiment disclosed in the present disclosure;

FIG. 2 shows a computer system that may be used to implement various components in an apparatus/device or various steps in a method described in the present disclosure;

FIG. 3 shows a flow diagram of an embodiment of a method in the present disclosure;

FIG. 4 shows deep neural network method for underwater geolocalization based on celestial-based underwater polarization information in low and high visibility waters by day and by night. (a)-(c) show that an underwater polarization sensitive imaging system with an omnidirectional lens are deployed in high and low visibility waters to collect data. False-color images of the angle of polarization (AoP) and a graph comparing observed AoP with the parametric model's prediction are displayed next to each drawing. Predictions made by the parametric model are unreliable in low visibility waters and it is ineffective at night. (d) shows that four different sites are selected as indicated on the global map to collect underwater data and to assess the effectiveness of our geolocalization method. (e) shows a deep neural network, in conjunction with a particle filter, uses sequences of AoP images to estimate the camera's position latitude and longitude;

FIG. 5 shows schematic diagrams of an exemplary embodiment in the present disclosure. (a) shows that underwater polarization patterns mainly result from the refraction of light between air-water interfaces and scattering within the water medium. These patterns can be mathematically modeled using Muller matrices. (b) shows that the particle filter (PF) pipeline is illustrated with high probability particles shown in red and low probability particles in blue. (c,d) show that the network model includes the RI-ResNet architecture, which replaces each convolution layer with its RI-Conv counterpart and accounts for the radial spatial structure in omnidirectional images. (e) shows that the RDM architecture involves a bidirectional recurrent network that models temporal dependencies between images;

FIG. 6 shows relative error between measured and predicted solar elevation and heading angles using parametric model in different sites around the world. (a) shows that angular prediction errors in Lake Ohrid, North Macedonia are relatively low due to high water visibility. (b)-(c) show that angular error predictions have both high and low errors during different solar elevation due to multiple scattering deficiencies in the parametric model;

FIG. 7 shows the root mean squared error of the estimated solar heading and elevation angles for both the parametric and deep neural network models (top and bottom). The parametric model solely considers single scattering phenomena, leading to greater solar angular errors in low visibility waters (Champaign, IL and Tampa, FL) in comparison to high visibility waters (Lake Ohrid, North Macedonia). Conversely, the deep neural network model learns intrinsic polarization patterns that arise from both single and multiple scattering, which results in similarly low solar angular errors in both low and high visibility waters;

FIG. 8 shows another embodiment of the present disclosure. (a) shows that the accuracy of underwater geolocalization predictions across the globe is significantly improved using a deep neural network (shown as a solid line) compared to a parametric model (shown as a dashed line). The global map illustrates the mean (shown as a diamond) and first standard deviation (shown as either a solid or dashed line) of the particle filter estimate for geolocation at the end of a day. The large errors observed in the mean and standard deviation of the estimated geolocation using the parametric approach are primarily due to a lack of understanding of the various physical phenomena that contribute to underwater polarization. (b)-(e) show that the close-up maps display the errors in the network model at a scale that allows the resolution of the covariance;

FIG. 9 shows geolocalization throughout the day in low and high visibility waters. The top row ((a) and (b)) and bottom row ((c) and (d)) show geolocalization accuracy throughout the day using the parametric model and the deep neural network model, respectively, in both high (left) and low (right) visibility waters. The parametric-based underwater geolocalization has moderate to low accuracy in low visibility waters due to model deficiencies in incorporating all physical phenomena that contribute to underwater polarization. In contrast, the deep neural network geolocalization performs uniformly well throughout the day in both high and low visibility waters. The individual maps display the mean (triangle and diamond) and first standard deviation (solid and dashed line) of the covariance of the particle filter estimate of geolocation at noon and at the end of the day, respectively. The box plots represent the median and upper/lower quartiles for the North-South (purple) and East-West (orange) geolocalization prediction errors;

FIG. 10 shows underwater geolocalization data at 50 m depth in Lake Ohrid, North Macedonia. (b) shows angle of polarization captured by the polarization imaging sensor with an omnidirectional lens at 14:00 local time on Aug. 15, 2022. (c) shows solar angular error and (d) shows geolocalization error across several hours at 50 m depth; and

FIG. 11 shows geolocalization accuracy during nighttime under different moon phases. (a) shows that the global map displays the mean (represented by a diamond) and first standard deviation (represented by a solid line) of the particle filter estimate of geolocation at the four sites (crosses) during the new moon and full moon phases. (b) shows that the box plots indicate the median and upper/lower quartiles for the North-South (purple) and East-West (orange) geolocalization prediction errors.

### DETAILED DESCRIPTION

The description and accompanying drawings above provide specific example embodiments and implementations. Drawings containing device structure and composition, for example, are not necessarily drawn to scale unless specifically indicated. Subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The embodiments of the present disclosure provide methods, apparatus, and non-transitory computer readable storage medium for determining underwater geolocation from light polarization images with neural networks.

Geolocalization is the process an agent (robot, sensor, etc.) uses to determine its location on earth, using local data. There are some problems/issues associated with underwater geolocation. For example, underwater geolocalization is complicated by the lack of signal propagation from satellite-based global positioning systems (GPS), as satellite-based GPS may have very limited water depth, for example, within a depth of 20 cm. Some implementations for underwater geolocalization have limited area coverage, or poor global accuracy. Reliable geolocalization is crucial for exploratory underwater missions, submarines, scuba divers, autonomous sampling robots, etc.

Some implementations for underwater geolocalization may include inertial navigation, acoustic navigation, and landmark identification, which may be complicated by landscape changes, nefarious agents, error accumulation, etc. Some implementations may use visual-based methods (e.g., using color/polarization images) with limited accuracy, and being only effective in clear waters during the day.

The present disclosure describes various embodiment of using polarized light to determining underwater geolocalization with deep-neural networks. The polarization image may be attribute to air-to-water light transmission, and/or in-water light scattering. Various embodiments in the present disclosure can achieve geolocalization at night, in low visibility waters, and at a depth of 50 meters in clear waters, and/or provide improvement on a previously implementations, using temporal data (the sequence of images) to determine geolocation of the sensor (or camera). Various embodiments may use deep neural networks trained on about 10 million polarization-sensitive images acquired globally, along with camera position sensor data, achieving good longitudinal accuracy (for example, about 55 km during daytime and/or about 1,000 km during nighttime at high water depths (for example, up to about 8 m) regardless of water turbidity. Some embodiments may achieve, in clear waters, a transfer learning longitudinal accuracy of about 255 km at 50 m water depth. By leveraging optical data in conjunction with camera position information, various embodiments in the present disclosure facilitate underwater geolocalization and offer a valuable tool for untethered underwater navigation.

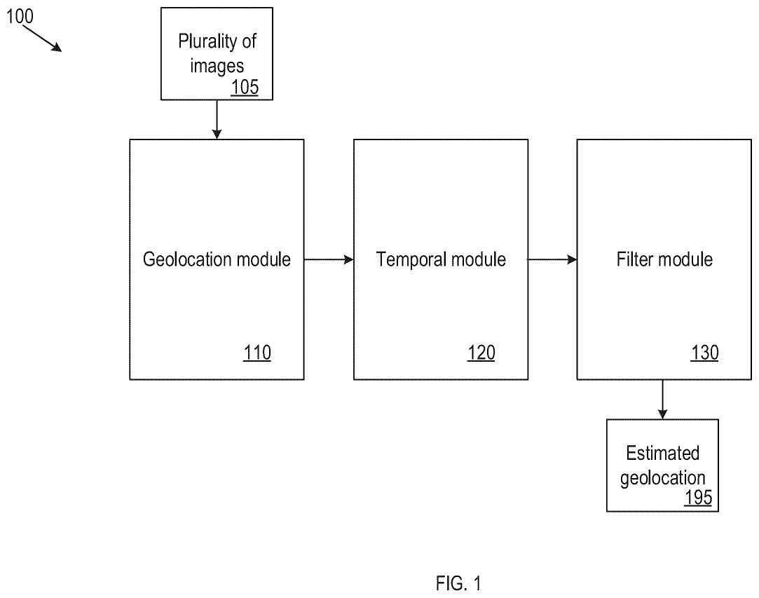

Referring now to FIG. 1 an exemplary embodiment 100 for determining underwater geolocation from light polarization images is shown. The embodiment 100 may include a portion or all of the following three components: a geolocation module 110, a temporal module 120, and/or a filter module 130. A plurality of images 105 may be used as input to the geolocation module, wherein the plurality of images may be a time sequence of polarization-sensitive images. For example, the plurality of underwater images may be acquired by one or more cameras capable of recording radial polarization light field at 20 frames per second. For another example, the plurality of images may be pre-stored in a storage device (e.g., an on-site data server or a remote cloud). The filter module may output a final estimated geolocation 195 according to the sequence of images.

The geolocation module 110 may include a deep neural network to predict a set of sun locations for each image frame. The deep neural network may include a rotation-invariant residual network (RI-ResNet), which include a plurality of RI-ResNet blocks. The RI-ResNet architecture may replaces each convolution layer with its RI-Conv counterpart (e.g., deformable convolutions) and/or account for the radial spatial structure in omnidirectional images. In some implementations, these convolutions have kernels oriented towards the center of the frame. In some implementations, a positional encoding map may be added to each frame that is calculated from inertial magnetic unit (IMU) data, wherein this positional encoding map may help to recover the true orientation of each pixel, irrespective of the camera's heading. In some implementations, by incorporating this positional encoding map, the RI-ResNet architecture may produce more reliable sun location predictions and may enable rotation-based data augmentation. In some implementations, an input angle of polarization images and the positional encoding map may be joined together by pixel-wise concatenation.

In some implementations, the RI-ResNet may be pretrained by using a mean-squared-error (MSE) loss which compares predicted sun location to ground-truth according to a training set of polarization images.

The temporal module 120 may include another neural network for refining the output from the geolocation module according to temporal information from the sequence of images. In some implementation, the neural network may be achieved by training a bidirectional gated recurrent unit (BiGRU) network, referred to as a recurrent denoising module (RDM), which may refine/smooth out the raw per-frame estimates. In some implementations, the RDM considers the entire list of RI-ResNet outputs and reduces the overall zigzaggedness of the curve they form. Bidirectional recurrent neural networks (e.g., BiGRU) may be used since the refinement of the sun location at a specific timestep depends on all previous and subsequent estimations. In some implementations, the RDM architecture involves a bidirectional recurrent network that models temporal dependencies between images, and may considers a plurality of RI-ResNet outputs to perform the refinement on the RI-ResNet outputs.

In some implementations, the RDM may be pretrained by using a training set of location predictions. In some other implementations, rather than utilizing the RI-ResNet output directly to train the RDM, a noisy input may be generated by adding Gaussian noise to the ground truth. This approach may be more effective and resilient. In some implementations, to optimize the RDM, a MSE loss may be used.

In some implementations, the geolocation module and the temporal module may be trained separately, and only during the evaluation phase, are combined the RI-ResNet and RDM.

The filter module may include a particle filter to estimate geolocation by using a plurality of location predictions, which may be output from the temporal module. In some implementations, the filter module may include another neural network to preform estimating geolocation based on the plurality of location predictions. In some implementations, the particle filter may use one or both parametric and data-driven models.

An electronic device may be used to perform one or more modules in FIG. 1. The electronic device may include a memory and a hardware-based processor. The memory may store instruction codes for the module, input data, output data, and/or any intermediate data. In some implementations, the memory may store one or more neural network (or other machine learning protocol). The processor may be in communication with the memory and execute instructions stored on the memory to perform any or all of the functionalities, for example, the processor may execute the neural network (or other machine learning protocol) stored on the memory.

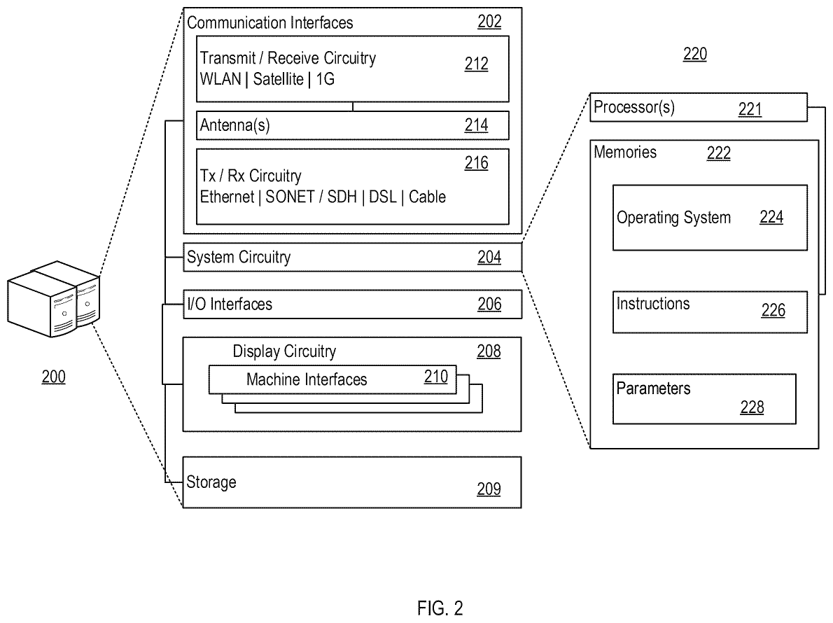

FIG. 2 shows an exemplary electronic device/apparatus for determining underwater geolocation from light polarization images with neural networks. The electronic device/apparatus may include a computer system 200 for implementing one or more steps in various embodiments of the present disclosure. The computer system 200 may include communication interfaces 202, system circuitry 204, input/output (I/O) interfaces 206, storage 209, and display circuitry 208 that generates machine interfaces 210 locally or for remote display, e.g., in a web browser running on a local or remote machine. For one example, the computer system 200 may communicate with one or more instrument (e.g., an polarization image capture subsystem). For another example, the computer system 200 may not directly communicate with the capture subsystem, but indirectly obtain image data (e.g., from a data server or a storage device), and then may process the image data to determining underwater geolocation using one or more neural network as described in the present disclosure.

The machine interfaces 210 and the I/O interfaces 206 may include GUIs, touch sensitive displays, voice or facial recognition inputs, buttons, switches, speakers and other user interface elements. Additional examples of the I/O interfaces 206 include microphones, video and still image cameras, headset and microphone input/output jacks, Universal Serial Bus (USB) connectors, general purpose digital interface (GPIB), peripheral component interconnect (PCI), PCI extensions for instrumentation (PXI), memory card slots, and other types of inputs. The I/O interfaces 206 may further include magnetic or optical media interfaces (e.g., a CDROM or DVD drive), serial and parallel bus interfaces, and keyboard and mouse interfaces.

The communication interfaces 202 may include wireless transmitters and receivers (“transceivers”) 212 and any antennas 214 used by the transmitting and receiving circuitry of the transceivers 212. The transceivers 212 and antennas 214 may support Wi-Fi network communications, for instance, under any version of IEEE 802.11, e.g., 802.11n or 802.11ac. The communication interfaces 202 may also include wireline transceivers 216. The wireline transceivers 216 may provide physical layer interfaces for any of a wide range of communication protocols, such as any type of Ethernet, data over cable service interface specification (DOCSIS), digital subscriber line (DSL), Synchronous Optical Network (SONET), or other protocol.

The storage 209 may be used to store various initial, intermediate, or final data or model for implementing various embodiments in the present disclosure. These data corpus may alternatively be stored in a database. In one implementation, the storage 209 of the computer system 200 may be integral with a database. The storage 209 may be centralized or distributed, and may be local or remote to the computer system 200. For example, the storage 209 may be hosted remotely by a cloud computing service provider.

The system circuitry 204 may include hardware, software, firmware, or other circuitry in any combination. The system circuitry 204 may be implemented, for example, with one or more systems on a chip (SoC), application specific integrated circuits (ASIC), microprocessors, discrete analog and digital circuits, and other circuitry.

For example, at least some of the system circuitry 204 may be implemented as processing circuitry 220. The processing circuitry 220 may include one or more processors 221 and memories 222. The memories 222 stores, for example, control instructions 226, parameters 228, and/or an operating system 224. The control instructions 226, for example may include instructions for implementing various components of various embodiment in the present disclosure. In one implementation, the instruction processors 221 execute the control instructions 226 and the operating system 224 to carry out any desired functionality related to the embodiment.

The present disclosure describes various embodiments of methods and/or apparatus for determining underwater geolocation from light polarization images with neural networks, which may include or be implemented by an electric device/system as shown in FIG. 2.

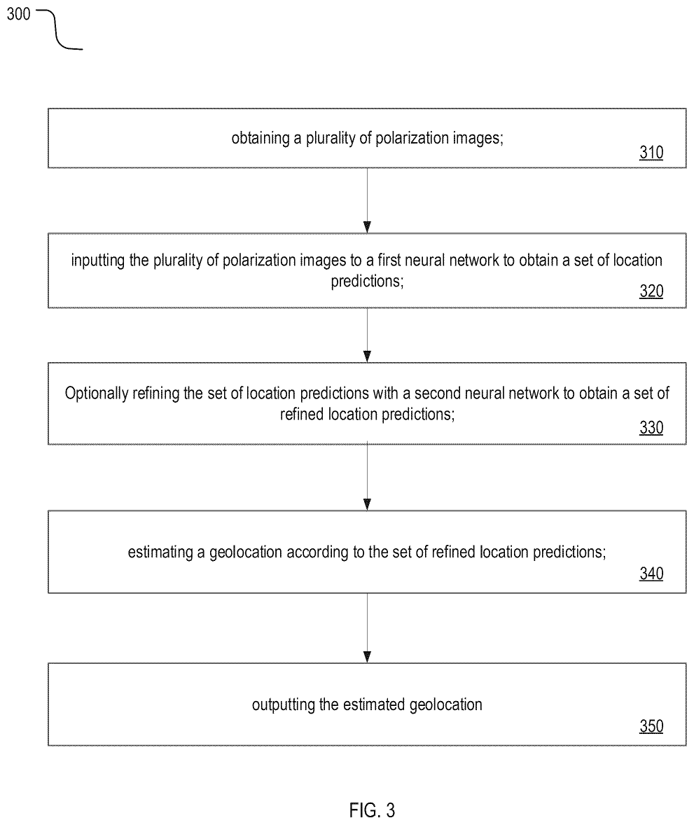

Referring to FIG. 3, the present disclosure describes various embodiments of a method 300 for determining underwater geolocation from light polarization images with neural networks. The method 300 may include a portion or all of the following steps: step 310, obtaining a plurality of polarization images; step 320, inputting the plurality of polarization images to a first neural network to obtain a set of location predictions; step 330, optionally refining the set of location predictions with a second neural network to obtain a set of refined location predictions; step 340, estimating a geolocation according to the set of refined location predictions; and/or step 350, outputting the estimated geolocation. The output geolocation may be received and/or processed by a navigation device or an operator, and is important for exploratory underwater missions, submarines, scuba divers, autonomous sampling robots, etc.

In some implementations, the plurality of polarization images is acquired by a polarization imaging sensor.

In some implementations, the plurality of polarization images comprises a time sequence of images.

In some implementations, the first neural network is pretrained according to a first training set of polarization images.

In some implementations, each prediction in the set of location predictions comprises a predication of a sun location.

In some implementations, each prediction in the set of location predictions is obtained with the first neural network based on each image in the plurality of polarization images.

In some implementations, the second neural network is pretrained according to a second training set of location predictions.

In some implementations, the second neural network refines the set of location predictions according to temporal information from the set of location predictions.

In some implementations, each refined prediction in the set of refined location predictions is obtained according to a plurality of predictions in the set of location predictions.

In some implementations, the estimating the geolocation comprises: estimating the geolocation with a particle filter according to the set of refined location predictions.

In some implementations, the estimating the geolocation comprises: estimating the geolocation with a third neural networks according to the set of refined location predictions.

In some implementations, the third neural network is pretrained according to a third training set of location predictions.

The present disclosure describes a few non-limiting embodiments for determining underwater geolocation from light polarization images with neural networks. The embodiments and/or example implementations below are intended to be illustrative embodiments and/or examples of the techniques and architectures discussed above. The example implementations are not intended to constrain the above techniques and architectures to particular features and/or examples but rather demonstrate real world implementations of the above techniques and architectures. Further, the features discussed in conjunction with the various example implementations below may be individually (or in virtually any grouping) incorporated into various implementations of the techniques and architectures discussed above with or without others of the features present in the various example implementations below.

### INTRODUCTION

Water is an essential component of the Earth's climate, but monitoring its properties using autonomous underwater sampling robots remains a significant challenge due to lack of underwater geolocalization capabilities. Current methods for underwater geolocalization rely on tethered systems with limited coverage or daytime imagery data in clear waters, leaving much of the underwater environment unexplored. Geolocalization in turbid waters or at night has been considered unfeasible due to absence of identifiable landmarks. The present disclosure describes methods for underwater geolocalization using deep neural networks trained on ˜10 million polarization-sensitive images collected around the world. Some embodiment achieves longitudinal accuracy of ˜55 km (˜1,000 km) during daytime (nighttime) at depths up to ˜8 m, regardless of water turbidity. In clear waters, the transfer learning longitudinal accuracy is ˜255 km at 50 m depth. The described method enables underwater geolocalization using solely optical data and provides a tool for tethered-free underwater navigation.

Earth's water surface is a complex and dynamic environment, encompassing vast oceans, seas, lakes, and rivers. The oceans alone account for over 70% of the Earth's surface area and contain an estimated 97% of the planet's water supply. Despite its importance, in situ monitoring of water properties remains challenging, and less precise satellite imaging is often used to capture water surface temperature, salinity, oxygen/nitrogen levels, and other parameters. Autonomous underwater sampling robots can provide more accurate in situ monitoring, but reliable geolocalization is required for their successful operation. As satellite-based global positioning system (GPS) does not work in the underwater environment, alternative methods for underwater localization have been explored with limited success. Despite advancements in acoustic navigation, landmark identification, and inertial navigation, underwater geolocalization still has limited area coverage or poor global accuracy. Small underwater vehicles and scuba divers face constraints on size and power for navigation devices, making precise inertial navigation and long-base-line acoustic navigation impractical. Visual-based underwater geolocalization using color and polarization images has demonstrated limited accuracy and is only effective in clear waters and during the day. Therefore, submersible vehicles and scuba divers frequently lack reliable geolocalization, which is crucial for exploratory underwater missions.

Migratory animals provide examples of precise navigation and geolocation in both air and water, spanning across the globe. These animals may rely on various sensory cues, including polarization-sensitive information from the sky or water. Light polarization patterns with structure are ubiquitous in both above- and underwater environments. Scattering of sunlight or moonlight in the upper atmosphere produces polarization patterns in the sky. Although humans cannot directly perceive light polarization, these patterns may be utilized for navigation with appropriate viewing equipment. Underwater polarization patterns result from two primary physical phenomena: predominantly unpolarized light emitted by the sun or reflected by the moon is first partially linearly polarized when it enters the water and then scattered by suspended particles.

Recordings of underwater polarization patterns may be preformed. As polarization imaging technology has advanced, better understanding of this hidden world has been gained through in situ measurements around the world. However, there are various problems/issues. For example, it was previously thought that underwater light was mainly horizontally polarized, making it unsuitable for geolocalization, which was noted as incorrect, likely due to measurement inaccuracies. It is suggested that underwater polarization fields could at least provide orientation information and potentially enable navigation. A recent study demonstrated geolocalization accuracy of 1,970 km using underwater polarization images in clear water. However, the usefulness of underwater polarization patterns observed in turbid water or at night has not been established. Polarization in turbid water has been dismissed as horizontal, and there are no recorded observations of underwater polarization patterns at night.

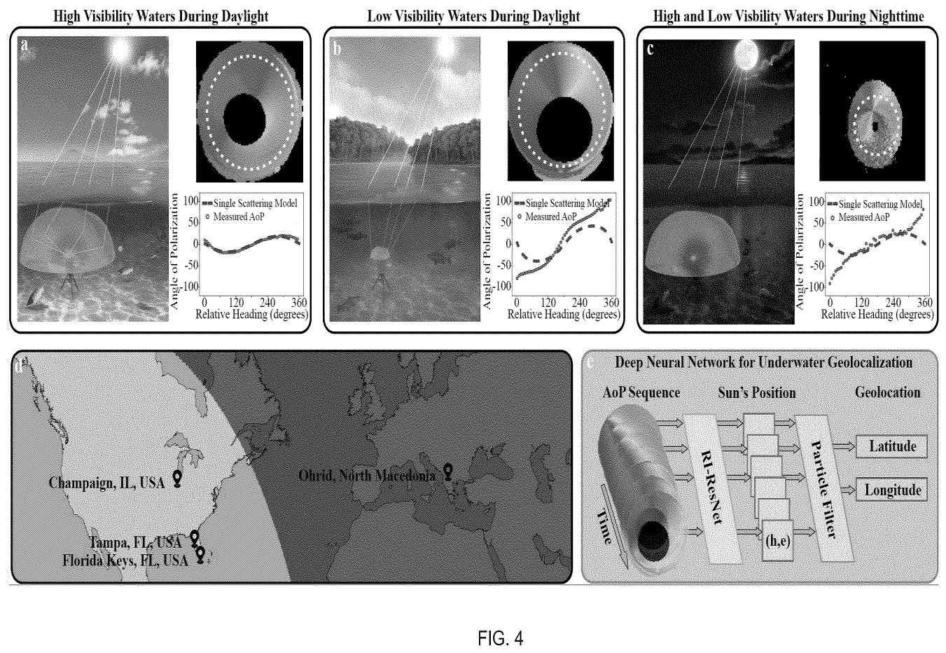

In open ocean waters or oligotrophic fresh waters with a low scattering coefficient (0.001 m⁻¹), underwater polarization patterns can be accurately represented by a single scattering model, as depicted in FIG. 4a. Therefore, straightforward inference procedures can be applied to achieve geolocalization in shallow clear water. However, in coastal ocean waters and eutrophic lakes where the scattering coefficient can be as high as 1 m⁻¹, the single scattering model is inadequate for predicting underwater polarization information, as evidenced by the underwater polarization patterns captured with an omnidirectional lens shown in FIG. 4b. Similarly, at night, underwater polarization patterns are influenced by both the moon and night sky contributions, making them challenging to model using the single scattering model, even in clear water at night, as illustrated in FIG. 4c, or at greater depths. This underscores the importance of developing new methods for geolocalization that can handle high-scattering waters and low-light conditions.

The present disclosure describes that even though direct inference through predictive models is unmanageable in many underwater situations, polarization patterns produced by daylight in low visibility water and by nightlight in both high and low visibility waters allow accurate geolocalization. First, ˜10 million images may be collected with underwater cameras capable of recording the radial polarization light field from four sites around the globe. Then a deep neural network may be trained to predict geolocation from underwater angle of polarization (AoP) images collected with an omnidirectional lens, as shown in FIG. 4e. Systematic comparison may be provided for underwater geolocalization accuracy between parametric and data driven model across time, date and different water visibility. It is demonstrate that using polarization information instead of intensity-only images results in superior geolocalization accuracy. Additionally, the present disclosure shows geolocalization at night, in low visibility waters, and at a depth of 50 meters in clear waters using transfer learning techniques.

### Underwater Data Collection and Geolocalization Methodology

Data were collected from four sites with varying visibility and salinity to evaluate our underwater geolocalization method. These included a freshwater lake in Champaign, IL, USA with a visibility of around 0.3 m; coastal sea waters in Florida Key, FL, USA with variable visibility ranging from 0.5 m to 3 m; sea water in the bay of Tampa, FL, USA with a visibility of around 0.5 m; and a freshwater lake in Ohrid, North Macedonia with visibility exceeding 10 m, as shown in FIG. 4d. The imaging instrument was placed on the sea or lake floor at depths of 1 m in Champaign, IL, 2 m in Florida during both winter and summer, and 8 m and 50 m in Ohrid, North Macedonia. Data was collected during the winter in the Florida Keys with a maximum sun elevation of around 40 degrees and during the summer in the bay of Tampa, FL with a maximum sun elevation of approximately 86 degrees.

The data from each site was divided randomly into a training set containing 80% of the data and a testing set containing the remaining 20%. The images in the training and testing data sets were collected on different dates and were spatially and temporally downsampled to 100 by 100 pixels and 1 frame per second, respectively. Frames in the training data where clouds completely obstructed the sun were manually removed. The purging was performed by personnel with no access to any trained model or test results to avoid introducing bias.

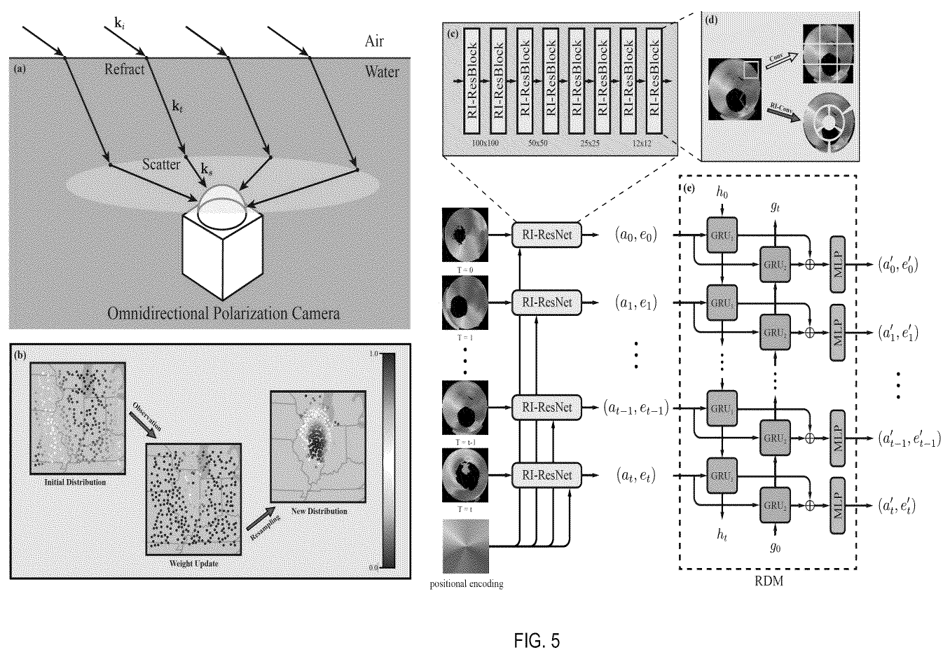

Underwater geolocalization was achieved via either parametric or data driven model. In the parametric model, theoretical modeling of single scattering is used to simulate underwater polarization patterns, as illustrated in FIG. 5a. This is achieved by utilizing a Muller matrix formalism to describe light scattering from particles in water and air-water refraction. To determine the camera's geolocation based on a set of underwater polarization images, the method estimates the sun's heading and elevation angles by minimizing the difference between measured and simulated underwater polarization angles. In our proposed network model, geolocation is predicted using a sequence of angle of polarization images in three stages (FIG. 5c-d). Firstly, a deep network leverages inertial magnetic unit parameters to predict a set of coarse sun locations (azimuth and elevation) for each frame individually. Secondly, temporal information is incorporated by another network to refine these coarse predictions, resulting in fine sun locations (FIG. 5e). Finally, both parametric and data-driven models use a particle filter to estimate geolocation (longitude and latitude) by utilizing a large batch of sun location predictions.

### Daytime Underwater Geolocalization Based on Polarization Images in Low and High Visibility Waters

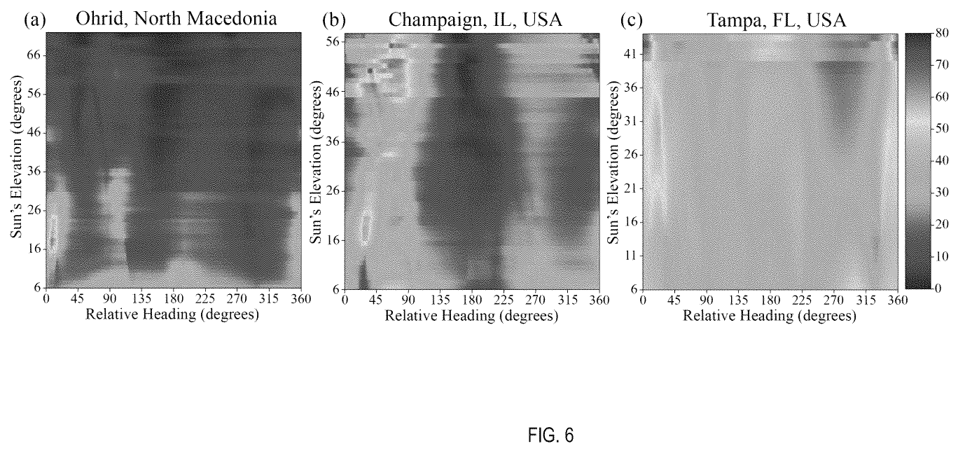

The accuracy of geolocalization using our developed deep neural network approach may be compared with that of a parametric method. In clear waters, such as Lake Ohrid, North Macedonia, the difference between the measured underwater angle of polarization and the parametric model is less than 10% when the sun's elevation is above approximately 30 degrees (FIG. 6a). However, during winter periods and summer sunrise and sunset, the sun's elevation is below 30 degrees, and the underwater polarization patterns are affected by light from both the sky and the sun (FIG. 6b). These light interactions are not well understood and are not included in the parametric model, resulting in estimated underwater angle of polarization with segments that have errors exceeding 50%. In low-visibility waters, such as those in Florida during the summer and winter periods (FIG. 6c), the estimated angle of polarization has errors exceeding 50% throughout the entire day due to the lack of multiple scattering effects in the parametric model.

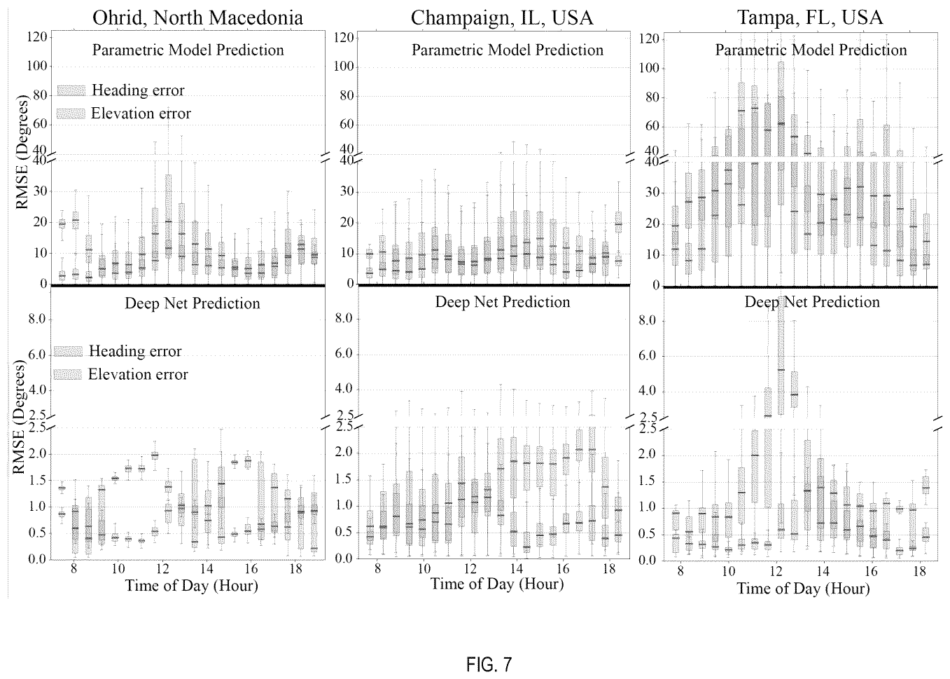

Significant inaccuracies in the estimated root mean squared errors (RMSEs) of the sun's heading and elevation angles arise from large modeling errors. For instance, the RMSEs for the sun's heading and elevation angles are 11.412° and 14.579° in Champaign, IL; 22.093° and 16.874° during the winter in Florida; 60.283° and 35.862° during the summer in Florida; and 14.362° and 11.113° in Lake Ohrid, North Macedonia, respectively (FIG. 7 top row). These errors are substantially reduced with our deep neural network approach, which produces at least one order of magnitude lower RMSEs compared to the parametric model at all sites (FIG. 7 bottom row). The RMSEs for the sun's heading and elevation angles using our deep neural network approach are 1.135° and 1.623° in Champaign, IL; 2.232° and 1.867° during the winter in Florida; 5.878° and 1.090° during the summer in Florida; and 1.290° and 0.845° at a depth of 8 m in Lake Ohrid, North Macedonia, respectively. The deep neural network approach consistently exhibits lower RMSEs for the sun's heading and elevation angles compared to the model-based approach throughout the day.

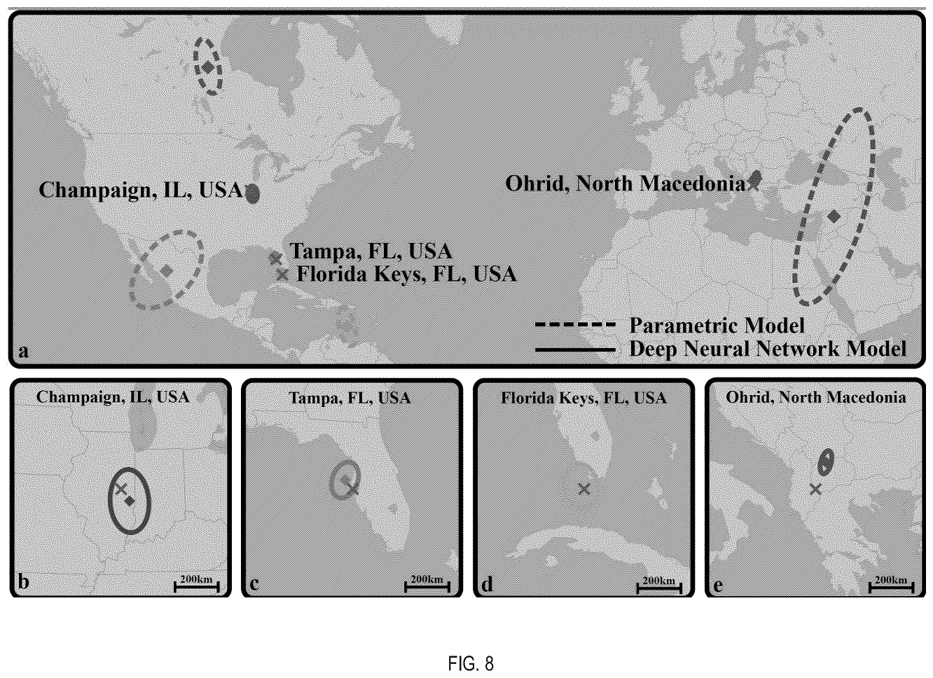

FIG. 8 displays the mean and one standard deviation for the particle filter covariance at the end of the day for both the parametric model (dashed line) and the deep neural network model (solid line) for the four locations around the globe. The parametric model-based geolocation predictions at the end of the day have a median error of 738 km and 1,416 km in the East-West and North-South directions in Champaign, IL; 1,519 km and 567 km in Florida during the winter; 3,947 km and 2,275 km in Florida during the summer; and 1,034 km and 629 km in Lake Ohrid, North Macedonia, respectively. By contrast, the deep neural network model yields more accurate initial angular estimates, leading to geolocalization errors of 55 km and 156 km in the East-West and North-South directions in Champaign, IL; 128 km and 78 km in Florida during the winter; 56 km and 64 km in Florida during the summer; and 50 km and 160 km at 8 m depth in Lake Ohrid, North Macedonia, respectively. The deep neural network-based geolocalization results are at least one order of magnitude more accurate than those of the parametric models.

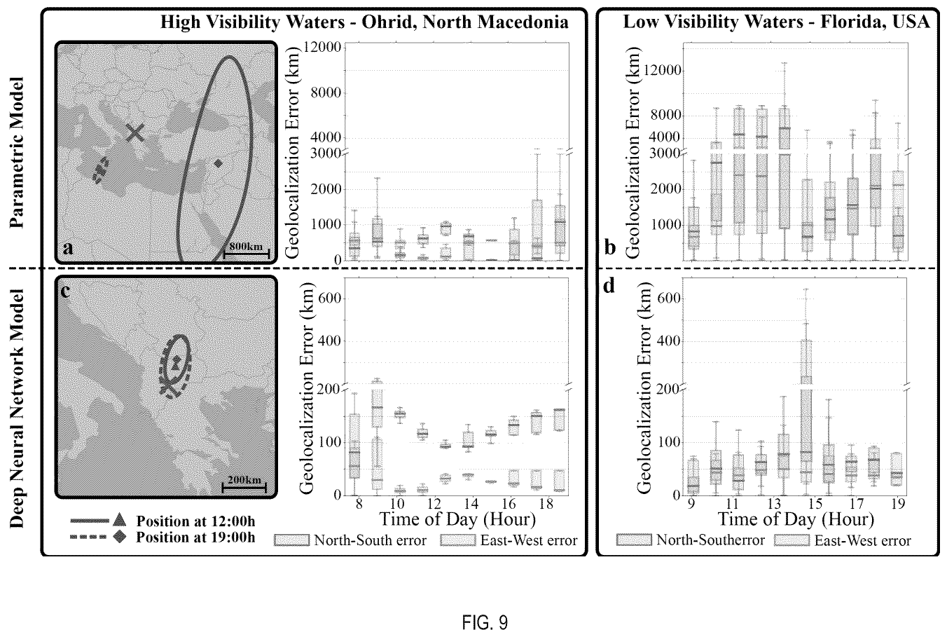

A geolocalization accuracy evaluation may be conducted throughout the day for both parametric and deep neural network methods. FIG. 9 displays the results for two sites with high mid-day solar elevations: one with high visibility waters (Ohrid, North Macedonia) and one with low visibility waters (Tampa, Florida during the summer). For the parametric model estimation, geolocalization accuracy is highest at mid-day and decreases towards the end of the day due to the lack of skylight contributions in the model. In low visibility waters, geolocalization error is uniformly high throughout the day, but the standard deviation decreases towards the end of the day due to particle filter noise reduction. The deep neural network model exhibits relatively constant but low errors throughout the entire day in both clear and low visibility waters, with slightly higher errors around mid-day in low visibility waters. This is likely due to the network having only observed a small number of images with high solar elevations (i.e., above 75°).

### Transfer Learning for Underwater Geolocalization at Depth

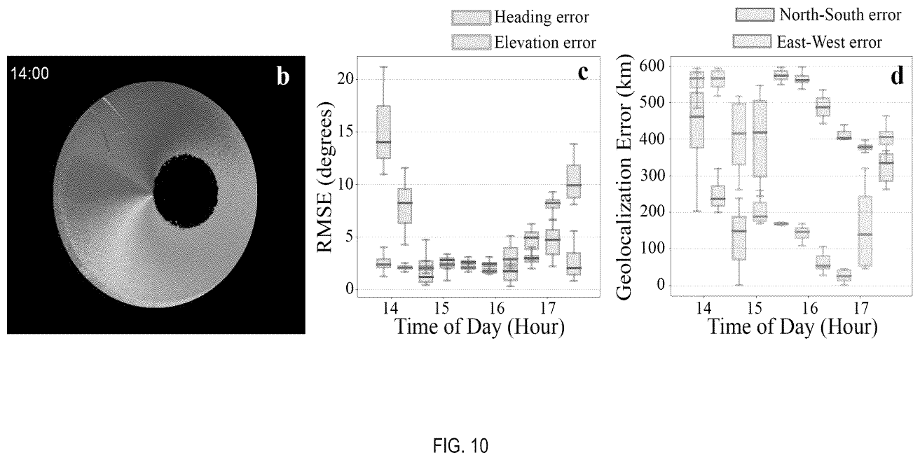

To assess the accuracy of underwater geolocalization at greater depths, polarization data may be collected at 50 m depth in Lake Ohrid, North Macedonia and the transfer learning capability may be evaluated. Continuous data were collected for several hours over two days. Data from 8 m depth was used to train the neural network, and data from 50 m depth was used to test geolocalization accuracy. The RMSEs for the sun's heading and elevation angle predictions were 6.605° and 4.236°, respectively. However, the geolocalization error in the East-West and North-South directions increased to 473 km and 255 km, respectively, as shown in FIG. 10.

The lower accuracy of geolocalization at greater depths is attributed to two factors. First, the interactions between light and water change as depth increases. Light undergoes multiple scattering and absorption events as it travels through deeper water. Although angle of polarization images at 8 m and 50 m depth appear visually similar, images at 50 m have lower degree of linear polarization and intensity than those at 8 m. The maximum degree of linear polarization recorded at 50 m is approximately 15%, compared to 35% at 8 m. Second, since the neural network is trained on angle of polarization images with higher degrees of linear polarization and intensity, it does not perform as well on images with lower degrees of polarization and intensity. As a result, the differences in noise profiles between the training and test data sets limit the accuracy of geolocalization predictions.

### Nighttime Underwater Geolocalization

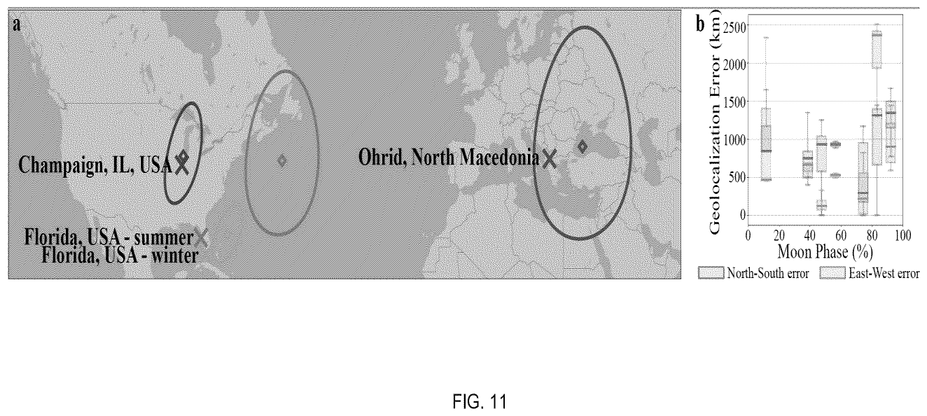

To assess the geolocalization accuracy at different moon phases, underwater polarization data at night across all four sites may be collected (FIG. 11). Because the underwater light intensity is much weaker at night than during the day, the camera exposure was set to 1 second for a moon cycle between full and gibbous, and to 10 seconds when the moon cycle was between crescent and quarter. However, due to the short recordings of less than two hours for crescent moon, the number of nighttime images used to train the deep neural network was limited. Despite this constraint, the RMSEs for the moon's heading and elevation were 19.404° and 7.160° in Champaign, IL; 43.019° and 10.056° in Florida during the winter; 37.392° and 15.297° in Florida during the summer; 12.947° and 3.552° in Lake Ohrid, North Macedonia, respectively. The final output from the particle filter provided nighttime geolocalization with East-West and North-South errors of 32 km and 357 km in Champaign, IL; 786 km and 1,307 km in Florida during the winter; 2,131 km and 1,650 km in Florida during the summer; 1,020 km and 285 km in Lake Ohrid, North Macedonia, respectively. Notably, the geolocalization accuracy was independent of the moon cycle (FIG. 11b).

### Daytime Underwater Geolocalization Based on Intensity Images

Two physical phenomena, refraction and in-water scattering, generate a radial intensity profile that depends on the sun's position, and it is possible to predict the solar angular position using intensity images from an omnidirectional gray scale camera. To test this hypothesis, the same data set and deep neural network architecture were used, and were trained with intensity-only images. The intensity data from four super pixels were added to generate an intensity image. Interestingly, for data collected in Champaign, IL and Lake Ohrid, North Macedonia, the solar angle predictions based on intensity images were similar to those based on polarization images. However, in Tampa, FL and the Florida Keys, the total RMSEs for solar angle predictions based on intensity images were 6.760° and 16.071°, respectively, compared to polarization-based RMSEs of 2.758° and 2.134°, respectively.

The water visibility in Lake Ohrid and in Champaign is different, but it remained relatively constant during the data collection period. The local lake in Champaign is small and not affected by wind conditions or rain, while the visibility and temperature of Lake Ohrid remain constant during summer periods. Despite the high turbidity and multiple light scattering events in the local lake in Champaign and the few scattering events due to the water clarity in Lake Ohrid, the network can recapitulate the underwater intensity image's dependence on solar angles in both cases due to the constant water environment. However, in both Florida sites, water visibility varied throughout the day and between different days due to currents, tides, and other environmental factors. These small changes in visibility introduce enough noise into the training set that prevented accurate solar prediction based on intensity images. However, angle of polarization remains robust to scattering perturbations in the water environment and helps improve solar angle predictions by the neural network.

### Underwater Imaging Instrument

The use of two distinct underwater housings, each with dome ports, may allow for the collection of the underwater data. The first housing was created by retrofitting a Blue Fin housing, while the second housing was custom-designed using Autocad and manufactured by PCBWay Incorporated. Both housings housed a polarization imaging sensor (e.g., FLIR Blackfly Polarization Monochrome Camera) which was equipped with a fisheye lens (e.g., Fujinon FE185C057HA-1) and an inertial magnetic unit (e.g., TCM-XB, PNI Sensor Corporation). Communication between the IMU and polarization camera was achieved via an I2C protocol. A 100 m underwater Ethernet cable was used to connect the polarization camera to a computer located on the shore. This cable provided power to the camera and IMU while simultaneously transmitting data to the computer. Data acquisition software, which was developed in Python, was used to record all video data in h5 format with IMU information. The camera could transmit up to 20 frames per second, and the information was stored in a 64 TB network area storage where the data was compressed every night for efficient storage.

### Underwater Data Collection and Preprocessing

The underwater camera system was mounted on an extruded aluminum platform, which was able to rotate freely for calibration data collection of the IMU. The calibration data was processed in Python using the imucal package. The imaging platform was then placed on the sea or lake floor at various depths, such as 1 m in Champaign, IL, 2 m in Florida during both winter and summer, and 8 m and 50 m in Ohrid, North Macedonia. In some sites, the entire platform was randomly rotated every day to collect a more diverse training set. During the day, the exposure time was set between 0.2 msec and 2 msec, and the frame rate was set to 20. At night, the camera exposure was set to 1 sec for a Moon cycle between full and gibbous (i.e. 1 frame per second) and 10 sec when the moon cycle was between crescent and quarter (i.e. 0.1 frame per second).

Prior to conducting experiments, the raw angle of polarization (AoP) image data may be preprocessed. Firstly, over a 15-frame temporal window were averaged to obtain images at 0.66 Hz (daytime) or 0.1 Hz (nighttime) to reduce stochastic noise and data redundancy. Next, background rows and columns were cropped from each frame, rescaled it to 100×100, and a calibration algorithm was performed. Finally, a human agent who had no access to the geolocalization models or their results identified noisy frames where the sun was either occluded by thick clouds or below the horizon.

Polarization-Based Underwater Geolocalization with Parametric Model

The underwater geolocalization parametric method employs a theoretical model of single scattering to simulate underwater polarization patterns (FIG. 5a). To determine the camera's geolocation based on a set of underwater polarization images, the method estimates the sun's heading and elevation angles by minimizing the difference between measured and simulated underwater polarization angles. Subsequently, a particle filter is employed to determine the geolocation g (i.e., longitude and latitude) using a sequence of sun angle predictions.

### Parametric Model for Underwater Polarization Patterns

To model underwater polarization patterns, a Muller matrix formalism is utilized to describe light scattering from particles in the water (M_{S}) and air-water refraction (M_{R}). Rotational matrices (M_{S→D} and M_{R→S}) are also included to account for any offsets between the different coordinate systems. The process begins with unpolarized sunlight, which is represented by a Stokes vector Sᵢ, and undergoes transmission from air to water before scattering from the particles suspended in the water. The following equation describes this process and yields the Stokes vector S_{d}, which corresponds to the underwater light as detected by the polarization-sensitive camera:

$${S}_{d} = {M}_{S \to D} {M}_{S} {M}_{R \to S} {M}_{R} {S}_{i} . \qquad ( 1 )$$

The Muller matrix for air-water refraction (M_{R}) can be calculated as follows:

$${M}_{R} = [ \begin{matrix}α + β & α - β & 0 & 0 \\ α - β & α + β & 0 & 0 \\ 0 & 0 & γ & 0 \\ 0 & 0 & 0 & γ\end{matrix} ] , \qquad ( 2 )$$

where α, β and γ are represented by the following three equations:

$$α = {\frac{1}{2} [ \frac{2 sin {θ}_{t} cos {θ}_{i}}{sin ( {θ}_{i} + {θ}_{t} ) cos ( {θ}_{i} - {θ}_{t} )} ]}^{2} , \qquad ( 3 )$$

$$β = {\frac{1}{2} [ \frac{2 sin {θ}_{t} cos {θ}_{i}}{sin ( {θ}_{i} + {θ}_{t} )} ]}^{2} , \qquad ( 4 )$$

$$γ = \frac{4 {sin}^{2} {θ}_{t} {cos}^{2} {θ}_{i}}{{sin}^{2} ( {θ}_{i} + {θ}_{t} ) {cos}^{2} ( {θ}_{i} - {θ}_{t} )} . \qquad ( 5 )$$

In the given equations, θᵢ and θₜ represent the incident and transmitted angles, respectively, and are determined by Snell's law using the refractive index of water relative to air, denoted by n:

$$sin {θ}_{i} = n sin {θ}_{t} . \qquad ( 6 )$$

The final step is summarized by the following equation, which utilizes the Muller matrix for Rayleigh scattering in the water medium:

$${M}_{S} = \frac{1}{2} [ \begin{matrix}1 + {cos}^{2} θ & {cos}^{2} θ - 1 & 0 & 0 \\ {cos}^{2} θ - 1 & 1 + {cos}^{2} θ & 0 & 0 \\ 0 & 0 & 2 ⋆ cos θ & 0 \\ 0 & 0 & 0 & 2 ⋆ cos θ\end{matrix} ] . \qquad ( 7 )$$

It is worth noting that the rotation matrix M_{R→S} and M_{S→D} are applied to rotate the coordinate system from the incident light beam to the transmitted beam and from the transmitted beam plane to the scattering plane, respectively. The rotational matrix can be expressed as follows:

$${M}_{R \to S , S \to D} = [ \begin{matrix}1 & 0 & 0 & 0 \\ 0 & cos ( 2 φ ) & sin ( 2 φ ) & 0 \\ 0 & - sin ( φ ϕ ) & cos ( 2 φ ) & 0 \\ 0 & 0 & 0 & 1\end{matrix} ] , \qquad ( 8 )$$

where φ is the angle of rotation. Our underwater imaging system captures the radial underwater polarization field in a single snapshot. The angle of polarization is computed using standard parametric equations from the raw data recorded by our polarization camera. To estimate the heading and elevation angles of the sun (h), a linear regression is performed by comparing the measured angle of polarization to the angle predicted by the single scattering model for different solar angles.

### Geolocalization Via Particle Filter

Sun position (h) may be converted to geolocation estimates (g) (longitude and latitude) in the last stage. The accuracy of geolocation estimates may be further improved by collecting a sequence of sun's heading and elevation observations hₜ over a period of time t∈1, . . . , T since the recording camera is stationary. To achieve this, a particle filter may be used to describe the posterior probability P(g|h₁, . . . , h_{T}).

Initializing a set of N particles may be started within a rectangular area of size 1000 km by 1000 km with uniform weight 1/N. Each particle represents a possible location of the camera, and its weight represents the probability of the particle being the true location. When a new measurement hₜ is received, the weight of the j-th particle is updated as follows:

$${P}^{′} ( {g}_{j} ) = P ( {g}_{j} ) \cdot P ( {h}_{t} \vert {g}_{j} ) , \qquad ( 9 )$$

and after all particles have been updated, their weights may be normalized to sum up to 1:

$$P ( {g}_{j} ) = \frac{{P}^{′} ( {g}_{j} )}{{\sum }_{k = 1}^{N} {P}^{′} ( {g}_{k} )} . \qquad ( 10 )$$

To obtain the conditional probability P(hₜ|gⱼ), it is observed from geolocation gⱼ at the same time as observation hₜ to determine the ground truth sun location, represented by

$${h}_{t}^{′} .$$

Then, a radial basis function (RBF) kernel may be used to compute the probability value, ranging from 0 to 1, as the similarity between

$${h}_{t}^{′}$$

and hₜ. Formally:

$$P ( {h}_{t} \vert {g}_{j} ) = exp ( - \frac{{‖ {h}_{t}^{′} - {h}_{t} ‖}^{2}}{2 {σ}^{2}} ) . \qquad ( 11 )$$

By comparing the computed sun locations of particles at each time-point with the prediction from the estimation model, high posterior probabilities may be assigned to particles that closely match the model's prediction across all hₜ's on the list. Conversely, particles that deviate from the model's prediction will receive low posterior probabilities. Ultimately, a distribution that indicates each particle's likelihood of being the camera's true geolocation may be determined.

Initially, N particles may be distributed over a large 1000×1000 km² rectangle, which results in a sparse distribution where even the most accurate particle can be tens of kilometers away from the ground truth location. To overcome this issue, a resampling strategy may be employed, where particles may be resampled based on their weights every M observations (M is a hyper-parameter chosen empirically). The new particles are perturbed with Gaussian noise to prevent overlap. This resampling procedure concentrates the particles closer to the current posterior mean and increases the resolution of geolocation. Our particle filter's architecture is shown in FIG. 5b. The mean geolocation may be obtained by computing the weighted mean of the particle locations, and the covariance is also calculated from the particles. The same particle filter design may be applied to the solar predictions from our deep neural network model, which will be explained in the following section.

Polarization-Based Underwater Geolocalization with Neural Network Model

Various network model may utilize a sequence of angle of polarization images, denoted as (x₀, . . . , xₜ), to predict geolocation in three steps. Firstly, a deep network predicts a set of coarse sun locations (azimuth and elevation), denoted as y₂=(aᵢ, eᵢ), for each frame xᵢ separately by incorporating its IMU parameters. Secondly, another network refines these coarse predictions using temporal information, resulting in fine sun locations denoted as (y₀′, . . . , yₜ′). Finally, a particle filter estimates the geolocation g (longitude and latitude) using a large batch of fine sun location predictions.

### Coarse Sun Location Prediction: RI-ResNet

A neural network may be based on the ResNet-18 architecture. However, this architecture has two drawbacks when applied to omnidirectional polarization images. Firstly, its convolution kernels are aligned to the sides of the frame, and hence they do not account for the true spatial relationship between pixels in the omnidirectional image. Secondly, the architecture is not rotation-invariant by design, meaning it cannot provide consistent predictions for frames that have similar sun locations but different camera orientations.

A solution may be introduced to these issues with a rotation-invariant ResNet (RI-ResNet), which replaces standard convolution layers with deformable convolutions. These convolutions have kernels oriented towards the center of the frame (FIG. 5d). Additionally, a positional encoding map may be added to each frame that is calculated from IMU data. This map helps to recover the true orientation of each pixel, irrespective of the camera's heading. The positional encoding map is defined as:

$${ϕ}_{i , j} = atan 2 ( i - H / 2 , j - W / 2 ) + θ , \qquad ( 12 )$$

$${p}_{i , j} = [ \begin{matrix}cos ( {ϕ}_{i , j} ) \\ sin ( {ϕ}_{i , j} )\end{matrix} ] . \qquad ( 13 )$$

The variable θ represents the yaw component of the IMU vector. As a result, p_{i,j} contains the absolute heading of pixel (i, j). By incorporating this positional encoding map, the RI-ResNet architecture produces more reliable sun location predictions and enables rotation-based data augmentation. Specifically, the calculation of the approximate sun location is expressed as:

$$y = {f}_{φ} ( x ⊕ p ) . \qquad ( 14 )$$

In the equation above, f_{φ} denotes the RI-ResNet, parametrized by φ. Note that the input angle of polarization image x and the positional encoding map p are joined together by pixel-wise concatenation (denoted by oplus). The RI-ResNet may be trained using a mean-squared-error (MSE) loss which compares predicted sun location to ground-truth. Formally:

$${ℒ}_{M S E} = {‖ y - {y}_{G T} ‖}_{2}^{2} . \qquad ( 15 )$$

Here y_{GT} is the ground truth sun location (azimuth and elevation). The overall architecture of RI-ResNet is visualized in FIG. 5c.

### Fine Sun Location Prediction: Recurrent Denoising Module

Next, the orderly path of the sun across the sky may be used to refine the per-frame sun location estimation. This is achieved by training a BiGRU network, referred to as the recurrent denoising module (RDM), which smooths out the raw perframe estimates. The RDM considers the entire list of RI-ResNet outputs (y₀, . . . , yₜ) and reduces the overall zigzaggedness of the curve they form. Since the refinement of the sun location at a specific timestep depends on all previous and subsequent estimations, bidirectional recurrent neural networks like BiGRU are preferred. The architecture of the RDM is illustrated in FIG. 5e. Mathematically,

$${h}_{k + 1} , {o}_{k + 1}^{( 1 )} = G R {U}_{1} ( {y}_{k} , {h}_{k} ) , \qquad ( 16 )$$

$${g}_{k + 1} , {o}_{k + 1}^{( 2 )} = G R {U}_{2} ( {y}_{t - k} , {g}_{k} ) , \qquad ( 17 )$$

$${y}_{k}^{′} = MLP ( {o}_{k + 1}^{( 1 )} ⊕ {o}_{t - k}^{( 2 )} ) . \qquad ( 18 )$$

Rather than utilizing the RI-ResNet output directly to train the RDM, the noisy input may be generated by adding Gaussian noise to the ground truth. This approach is more effective and resilient. Only during the evaluation phase the RI-ResNet and RDM may be combined. To optimize the RDM, the same MSE loss may be used.

$${ℒ}_{M S E} = {‖ RD M ( {y}_{G T} + ϵ ) - {y}_{G T} ‖}_{2}^{2} , ϵ ∼ 𝒩 ( 0 , σ ) . \qquad ( 19 )$$

The present disclosure describes learning-based methods for highly accurate underwater geolocalization using an omnidirectional polarization camera. The approach is effective across multiple sites worldwide and improves geolocalization accuracy compared to the traditional parametric model by an order of magnitude. In addition, for the first time, polarization-based geolocalization in low visibility waters and at night is demonstrated.

Underwater imaging in turbid waters or at night poses a significant challenge due to the limited amount of ambient light available to capture images. The presence of suspended particles in the water also scatters the light, further complicating the image capture process. The scattering of light can cause changes in the polarization of light, making it difficult to accurately measure the underwater environment. These factors make geolocalization using images captured in turbid waters or at night incredibly difficult, if not impossible using physics-based models.

The physical properties of water can significantly impact the underwater polarization patterns, leading to distinctive changes in polarization at different locations. For instance, variations in particle density, oxygenation, pollution, and depth can all contribute to alterations in polarization patterns. Moreover, complex relief in the water can cause blocked scattered light, further influencing polarization. In this context, creating maps of local water properties may enable more precise geolocation, and localization at a fine scale may be feasible even in the presence of relief.

Various methods for high-accuracy geolocalization using polarization in clear and turbid waters, day or night, and at greater depths are described. This method offers a potential new way for aquatic creatures to navigate, even in low-visibility conditions. By using underwater background polarization information, they may be able to find their way around and reach their destination with greater accuracy. This could have significant implications for marine life, as well as for human activities such as underwater exploration and search and rescue missions.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed:

1. A method for determining underwater geolocation from polarization images with neural networks, the method comprising:
obtaining, by a device comprising a memory and a processor in communication with the memory, a plurality of polarization images;
inputting, by the device, the plurality of polarization images to a first neural network to obtain a set of location predictions;
estimating, by the device, a geolocation according to the set of location predictions; and
outputting, by the device, the estimated geolocation.

2. The method according to claim 1, wherein:
the plurality of polarization images is acquired by a polarization imaging sensor.

3. The method according to claim 1, wherein:
the plurality of polarization images comprises a time sequence of images.

4. The method according to claim 1, wherein:
the first neural network is pretrained according to a first training set of polarization images.

5. The method according to claim 1, wherein:
each prediction in the set of location predictions comprises a predication of a sun location.

6. The method according to claim 1 wherein:
each prediction in the set of location predictions is obtained with the first neural network based on each image in the plurality of polarization images.

7. The method according to claim 1, further comprising:
refining, by the device, the set of location predictions with a second neural network to obtain a set of refined location predictions; and
wherein the estimating the geolocation according to the set of location predictions comprises estimating the geolocation according to the set of refined location predictions.

8. The method according to claim 7, wherein:
the second neural network is pretrained according to a second training set of location predictions.

9. The method according to claim 7, wherein:
the second neural network refines the set of location predictions according to temporal information from the set of location predictions.

10. The method according to claim 7 wherein:
each refined prediction in the set of refined location predictions is obtained according to a plurality of predictions in the set of location predictions.

11. The method according to claim 7, wherein the estimating the geolocation comprises:
estimating the geolocation with a particle filter according to the set of refined location predictions.

12. The method according to claim 7, wherein the estimating the geolocation comprises:
estimating the geolocation with a third neural network according to the set of refined location predictions.

13. The method according to claim 12, wherein:
the third neural network is pretrained according to a third training set of location predictions.

14. An apparatus for determining underwater geolocation from polarization images with neural networks, the apparatus comprising:
a memory storing instructions; and
a processor in communication with the memory, wherein, when the processor executes the instructions, the processor is configured to cause the apparatus to perform:
obtaining a plurality of polarization images,
inputting the plurality of polarization images to a first neural network to obtain a set of location predictions,
estimating a geolocation according to the set of location predictions, and
outputting the estimated geolocation.

15. The apparatus according to claim 14, wherein:
the plurality of polarization images is acquired by a polarization imaging sensor.

16. The apparatus according to claim 14, wherein:
when the processor executes the instructions, the processor is configured to further cause the apparatus to perform refining the set of location predictions with a second neural network to obtain a set of refined location predictions; and
when the processor is configured to cause the apparatus to perform the estimating the geolocation, the processor is configured to cause the apparatus to perform estimating the geolocation according to the set of refined location predictions.

17. The apparatus according to claim 16, wherein:
the second neural network is pretrained according to a second training set of location predictions.

18. A non-transitory computer-readable medium storing instructions, wherein, when the instructions are executed by a processor, the instructions are configured to cause the processor to perform:
obtaining a plurality of polarization images,
inputting the plurality of polarization images to a first neural network to obtain a set of location predictions,
estimating a geolocation according to the set of location predictions, and
outputting the estimated geolocation.

19. The non-transitory computer-readable medium according to claim 18, wherein:
the plurality of polarization images is acquired by a polarization imaging sensor.

20. The non-transitory computer-readable medium according to claim 18, wherein:
when the instructions are executed by the processor, the instructions are configured to further cause the processor to perform refining the set of location predictions with a second neural network to obtain a set of refined location predictions; and
when the instructions are configured to cause the processor to perform the estimating the geolocation, the instructions are configured to cause the processor to perform estimating the geolocation according to the set of refined location predictions.
